(19) United States
(12) Patent Application Publication
(10) Pub. No.: US 2008/0082320 A1
(43) Pub. Date: Apr. 3, 2008

(54) APPARATUS, METHOD AND COMPUTER PROGRAM PRODUCT FOR ADVANCED VOICE CONVERSION

(75) Inventors: Victor Popa, Tampere (FI); Jani K. Nurminen, Lempaala (FI); Jilei Tian, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/537,428

(22) Filed: Sep. 29, 2006

(51) Int. Cl. G10L 19/00

(52) U.S. Cl. 704/201

(57) ABSTRACT

An apparatus is provided that includes a converter for training a voice conversion model for converting source encoding parameters characterizing a source speech signal associated with a source voice into corresponding target encoding parameters characterizing a target speech signal associated with a target voice. To reduce the affect of noise on the voice conversion model, the converter may be configured for receiving sequences of source and target encoding parameters, and train the model without one or more frames of the source and target speech signals that have energies less than a threshold energy. After conversion of the respective parameters, then, the converter, a decoder or another component may be configured for reducing the energy of one or more frames of the target speech signal that have an energy less than the threshold energy, where the threshold value may be adaptable based upon models of speech frames and non-speech frames.

### FIELD OF THE INVENTION

Embodiments of the present invention generally relate to apparatuses and methods of speech processing and, more particularly, relate to apparatuses and methods of converting a source speech signal associated with a source voice into a target speech signal that is a representation of the source speech signal, but is associated with a target voice.

### BACKGROUND OF THE INVENTION

Voice conversion can be defined as the modification of speaker-identity related features of a speech signal. Voice conversion techniques may be utilized in a number of different contexts. For example, voice conversion may be utilized to extend the language portfolio of Text-To-Speech (TTS) systems for branded voices in a cost efficient manner. In this context, voice conversion may for instance be used to make a branded synthetic voice speak in languages that the original voice talent cannot speak. In addition, voice conversion may be deployed in several types of entertainment applications and games, while there are also several new features that could be implemented using the voice conversion technology, such as text message reading with the voice of the sender.

A plurality of voice conversion techniques are already known in the art. In accordance with such techniques, a speech signal is frequently represented by a source-filter model of speech whereby a source component of speech, originating from the vocal cords, is shaped by a filter imitating the effect of the vocal tract. In this regard, the source component is frequently denoted as an excitation signal as it excites the vocal tract filter. Separation (or deconvolution) of a speech signal into the excitation signal on the one hand, and the vocal tract filter on the other hand can, for instance, be accomplished by cepstral analysis or Linear Predictive Coding (LPC).

LPC is a technique of predicting a sample of a speech signal s(n) as a weighted sum of a number p of previous samples where the number p of previous samples may be denoted as the order of the LPC. The weights aₖ (or LPC coefficients) applied to the previous samples may be chosen in order to minimize the squared error between the original sample and its predicted value (i.e., the error signal e(n)), which is sometimes referred to as LPC residual. Applying the z-transform, it is then possible to express the error signal E(z) as the product of the original speech signal S(z) and a transfer function A(z) that entirely depends on the weights aₖ. The spectrum of the error signal E(z) may have different structure depending on whether a sound from which it originates is voiced or unvoiced. Voiced sounds are typically produced by vibrations of the vocal cords, and their spectrum is often periodic with some fundamental frequency (which corresponds to the pitch). As a result, the error signal E(z) and transfer function A (z) may be considered representative of the excitation and vocal tract filter, respectively. The weights aₖ that determine the transfer function A (z) may, for instance, be determined by applying an autocorrelation or covariance technique to the speech signal. LPC coefficients can also be represented by Line Spectrum Frequencies (LSFs), which may be more suitable for exploiting certain properties of the human auditory system.

Whereas conventional voice conversion techniques are adequate, they have a number of drawbacks. In this regard, conventional voice conversion techniques are premised on models trained on aligned and clean speech from source and target speakers, and perform better converting clean speech. However, it is common in a number of applications of such techniques, such as in the context of mobile terminals, that the speech (e.g., target speaker speech) for conversion is received from a noisy environment. And conventional voice conversion techniques generally lack proper solutions for dealing with such noisy environments to convert voice with a desired quality. In addition, silent-like, pause segments in speech signals may be amplified to introduce artificial noise in corresponding segments of the converted speech in the case where both training speeches from source and target speakers are clean.

### SUMMARY OF THE INVENTION

In light of the foregoing background, exemplary embodiments of the present invention provide an improved system, method and computer program product for training voice conversion models (e.g., Gaussian Mixture Model (GMM)-based models) from based on aligned speeches segments of source and target speakers less affected by noise (without similar segments more affected by noise). In addition, the improved system, method and computer program product exemplary embodiments of present invention may perform noise-robust voice conversion. In accordance with exemplary embodiments of the present invention, energy statistics of speech and non-speech segments may lead to efficient selection of high signal-to-noise ratio (SNR) frames for training (clean data) and enable effective attenuation of non-speech segments (prone to disturbing distortions) of a converted signal. The system, method and computer program product of exemplary embodiments of the present invention are flexible, allowing adaptive implementation, and are well suited for the real-time, light computation requirements of voice conversion applications. And exemplary embodiments of the present invention are particularly efficient in the context of mobile terminal applications where speech signals from target speakers are often noisy.

According to one aspect of the present invention, an apparatus is provided. The apparatus includes a converter for training a voice conversion model for converting at least some information characterizing a source speech signal (e.g., source encoding parameters) into corresponding information characterizing a target speech signal (e.g., target encoding parameters). In this regard, the source speech signal is associated with a source voice, and the target speech signal is a representation of the source speech signal associated with a target voice. To train the voice conversion model, the converter may be configured for receiving information characterizing each frame in a sequence of frames of a source speech signal (e.g., sequence of source encoding parameters) and information characterizing each frame in a sequence of frames of a target speech signal (e.g., sequence of target encoding parameters).

Each frame of the source and target speech signals may have an associated energy (e.g., energy parameter). The converter may therefore be configured for comparing the energies of the frames of the source and target speech signals to a threshold energy value, and identifying one or more frames of the source and target speech signals that have energies less than the threshold energy value. The converter may then be configured for training the voice conversion model based upon the information characterizing at least some of the frames in the sequences of frames of the source and target speech signals, where the conversion model may be trained without the information characterizing at least some of the identified frames.

After training the voice conversion model, the converter may be further configured for receiving information characterizing each of a plurality of frames of a source speech signal from an encoder, and be configured for converting at least some of the information characterizing each of the frames of the source speech signal into corresponding information characterizing each of a plurality of frames of a target speech signal. Information characterizing each frame of the target speech signal may therefore include the converted information, and include the energy of the respective frame, which may configured for a decoder to synthesize the target speech signal.

Before synthesizing the target speech signal, the converter, decoder or another component located between the converter and decoder may be configured for reducing the energy of one or more frames of the target speech signal that have an energy less than the threshold energy value. The converter, decoder or other component may then be configured for passing the information characterizing the frames of the target speech signal including the reduced energy to the decoder for synthesizing the target speech signal (passing the information being within the decoder in instances in which the decoder is configured for reducing the energy). Further, the converter, decoder or other component may be configured for building models of speech frames and non-speech frames based upon the received information characterizing the source speech signal. The converter, decoder or other component may then be configured for adapting the threshold energy value based upon the models, the threshold energy value representing a delineation between the speech frames and the non-speech frames.

According to other aspects of the present invention, a method and computer program product are provided. Exemplary embodiments of the present invention therefore provide an improved system, method and computer program product. And as indicated above and explained in greater detail below, the system, method and computer program product of exemplary embodiments of the present invention may solve the problems identified by prior techniques and may provide additional advantages.

### BRIEF DESCRIPTION OF THE DRAWINGS

Having thus described the invention in general terms, reference will now be made to the accompanying drawings, which are not necessarily drawn to scale, and wherein:

FIGS. 1a-1c are schematic block diagrams of a framework for voice conversion according to different exemplary embodiments of the present invention;

FIGS. 2a-2c are schematic block diagrams of a telecommunications apparatus including components of a framework for voice conversion according to different exemplary embodiment of the present invention;

FIGS. 3a-3c are schematic block diagrams of a text-to-speech converter according to different exemplary embodiments of the present invention;

FIG. 4 is a histogram of the energies of speech and non-speech frames, in accordance with exemplary embodiments of the present invention;

FIG. 5 is a series of histograms illustrating the selection of E_{Cmax} in accordance with one embodiment of the present invention;

FIG. 6 is a series of histograms illustrating the selection of wE_{Smax} in accordance with one embodiment of the present invention;

FIG. 7 is a representation of the threshold energy Eₜᵣ in accordance with one embodiment of the present invention;

FIG. 8 is a graph illustrating a power gamma function, in accordance with exemplary embodiments of the present invention; and

FIG. 9 is a flowchart including various steps in a method of voice conversion in accordance with exemplary embodiments of the present invention.

### DETAILED DESCRIPTION OF THE INVENTION

The present invention now will be described more fully hereinafter with reference to the accompanying drawings, in which preferred exemplary embodiments of the invention are shown. This invention may, however, be embodied in many different forms and should not be construed as limited to the exemplary embodiments set forth herein; rather, these exemplary embodiments are provided so that this disclosure will be thorough and complete, and will fully convey the scope of the invention to those skilled in the art. Like numbers refer to like elements throughout.

Exemplary embodiments of the present invention provide a system, method and computer program product for voice conversion whereby a source speech signal associated with a source voice is converted into a target speech signal that is a representation of the source speech signal, but is associated with a target voice. Portions of exemplary embodiments of the present invention may be shown and described herein with reference to the voice conversion framework disclosed in U.S. patent application Ser. No. 11/107,344, entitled: Framework for Voice Conversion, filed Apr. 15, 2005, the contents of which are hereby incorporated by reference in its entirety. It should be understood, however, that exemplary embodiments of the present invention may be equally adaptable to any of a number of different voice conversion frameworks. As explained herein, the framework of the U.S. patent application Ser. No. 11/107,344 is a parametric framework wherein speech may be represented using a set of feature vectors or parameters. It should be understood, however, that exemplary embodiments of the present invention may be equally adaptable to any of a number of other types of frameworks (e.g., waveform frameworks, etc.).

In accordance with exemplary embodiments of the present invention, a source speech signal may be converted into a target speech signal. More particularly, in accordance with a parametric voice conversion framework of one exemplary embodiment of the present invention, encoding parameters related to the source speech signal (source encoding parameters) may be converted into corresponding encoding parameters related to the target speech signal (target encoding parameters). As explained above, a speech signal is frequently represented by a source-filter model of speech whereby a source component of speech (excitation signal), originating from the vocal cords, is shaped by a filter imitating the effect of the vocal tract (vocal tract filter). Thus, for example, vocal tract filter and/or excitation encoding parameters related to the source speech signal may be converted into corresponding vocal tract filter and/or excitation encoding parameters related to the target speech signal.

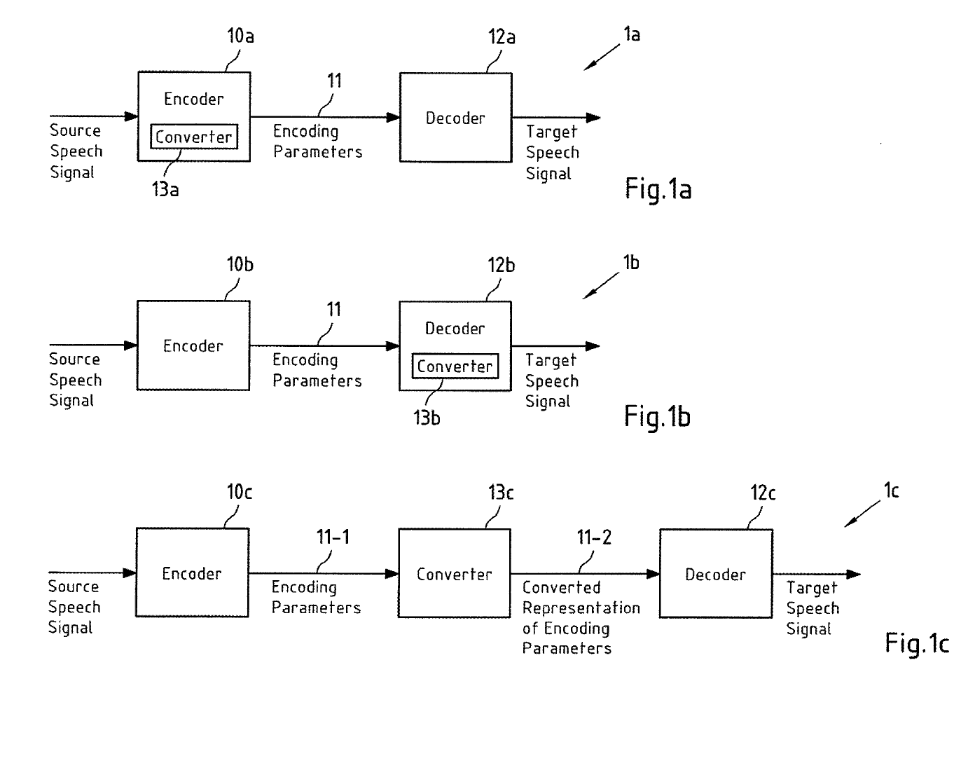

FIGS. 1a-1c are schematic block diagrams of a framework for voice conversion according to different exemplary embodiments of the present invention. Turning to FIGS. 1a and 1b first, in each framework 1a, 1b, an encoder 10a, 10b is configured for receiving a source speech signal associated with a source voice, and for encoding the source speech signal into encoding parameters. The encoding parameters may then pass via a link 11 to decoder 12a, 12b, which is configured for decoding the encoding parameters into a target speech signal. In accordance with voice conversion, the target speech signal is a representation of the source speech signal, but is associated with a target voice that is different from the source voice. The actual conversion of the source voice into the target voice is accomplished by a converter, which in the embodiments of FIGS. 1a and 1b may be located in either the encoder or decoder. In framework 1a, the encoder 10a may include the converter 13a, whereas in framework 1b, the decoder 12b may include the converter 13b. Both converters may be configured for converting encoding parameters related to the source speech signal (denoted as source parameters) into encoding parameters related to the target signal (denoted as target parameters).

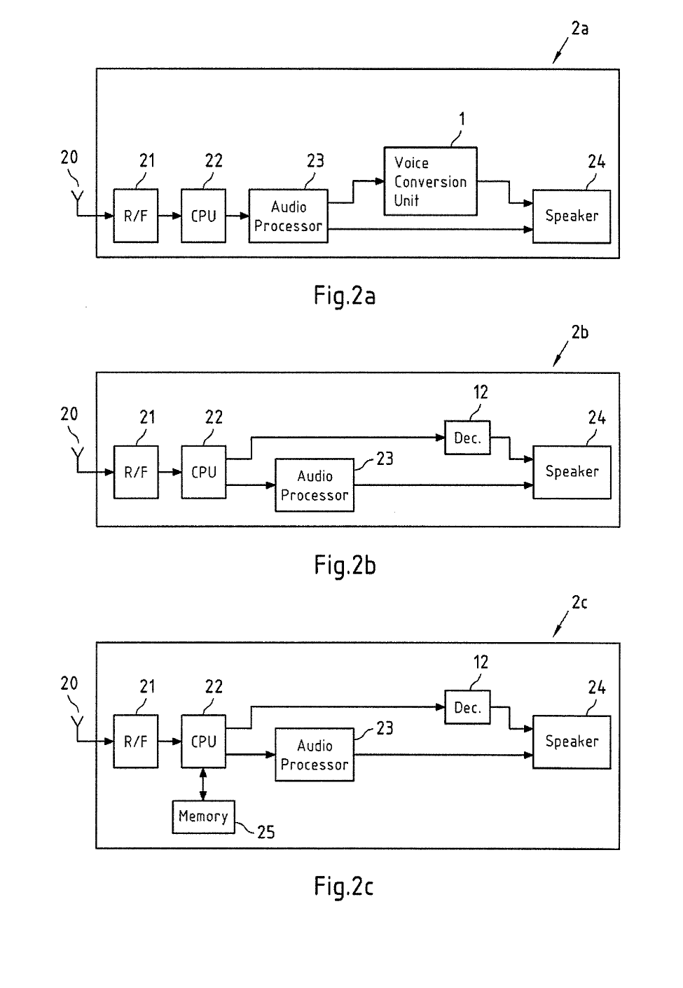

As shown and described herein, the encoder 10a, 10b and decoder 12a, 12b of the framework 1a, 1b may be implemented in the same apparatus, such as within a module of a speech processing system. In such instances, the link 11 may be a simple electrical connection. Alternatively, however, the encoder and decoder may be implemented in different apparatuses, and in such instances, the link 11 may be a transmission link (wired or wireless link) between the apparatuses. Locating the encoder and decoder in different apparatuses may be particularly useful in various contexts, such as that of a telecommunications system, as will be discussed with reference to FIGS. 2a-2c below.

FIG. 1c illustrates a framework 1c of yet another exemplary embodiment of the present invention, where the converter 13c is implemented in a component separate from the encoder 10c and decoder 12c. In this regard, the encoder may be configured for encoding a source speech signal into encoding parameters, which may be transferred via link 11-1 to the converter. The converter may convert the encoding parameters into a converted representation thereof, or more particularly convert source parameters into target parameters. The converter may then forward the converted representation of the encoding parameters via a link 11-2 to the decoder. In turn, the decoder may be configured for decoding the converted representation of the encoding parameters into the target speech signal. The encoder, decoder and converter of the framework of FIG. 1c may be logically separate but co-located in one apparatus. In such instances, the links between the encoder, decoder and converter may be, for example, electrical connections. Alternatively, one or more of the encoder, decoder and converter may be located in different apparatuses or systems such that the links therebetween comprise transmission links (wired or wireless).

FIG. 2a illustrates a block diagram of a telecommunications apparatus 2a, such as a mobile terminal operable in a mobile communications system, including components of a framework for voice conversion according to one exemplary embodiment of the present invention. A typical use case of such an apparatus is the establishment of a call via a core network of the mobile communications system. As shown, the apparatus includes an antenna 20, an R/F (radio frequency) instance 21, a central processing unit (CPU) 22 or other processor or controller, an audio processor 23 and a speaker 24, although it should be understood that the apparatus may include other components for operation in accordance with exemplary embodiments of the present invention. The antenna may be configured for receiving electromagnetic signals carrying a representation of speech signals, and passing those signals to the R/F instance. The R/F instance may be configured for amplifying, mixing and analog-to-digital converting the signals, and passing the resulting digital speech signals to the CPU. In turn, the CPU may be configured for processing the digital speech signals and triggering the audio processor to generate a corresponding analog speech signal for emission by the speaker.

As also shown in FIG. 2a, the apparatus 2a may further include a voice conversion unit 1, which may be implemented according any of the frameworks 1a, 1b and 1c of FIGS. 1a, 1b and 1c, respectively. The voice conversion unit may be configured for converting the source voice of the source speech signal (output by the audio processor 23) into a target voice, and for forwarding the resulting speech signal to the speaker 24. This allows a user of the apparatus to change the voices of all speech signals output by the audio processor (e.g., speech signals from mobile calls, spoken mailbox menus, etc.).

FIG. 2b illustrates a block diagram of a telecommunications apparatus 2b including components of a framework for voice conversion according to another exemplary embodiment of the present invention. As shown, components of apparatus 2b with the same function as those of their counterparts in apparatus 2a of FIG. 2a are denoted with the same reference numerals. In contrast to apparatus 2a of FIG. 2a, apparatus 2b of FIG. 2b includes a decoder 12 in lieu of a complete voice conversion unit, where the decoder is connected to the CPU 22 and the speaker 24. The decoder may be configured for decoding encoding parameters (received from the CPU) into speech signals, which may then be fed to the speaker. In this regard, the encoding parameters may be received by apparatus 2b from a core network of a mobile communications system within which the apparatus operates, for example. Then, instead of transmitting speech data, the core network may use an encoder (not shown) to encode the speech data into encoding parameters, which may then be directly transmitted to apparatus 2b. This may be particularly useful if the encoding parameters represent frequently required speech signals (e.g., spoken menu items that can be read to visually impaired persons, etc.), and thus can be stored in the core network in the form of encoding parameters. The encoder in the core network may include a converter for performing voice conversion, such as to implement the framework 1a of FIG. 1a. Similarly, the decoder in apparatus 2b may include a converter for performing voice conversion, such as to implement the framework 1b of FIG. 1b. In another alternative, a separate conversion unit may be located on the path between the encoder in the core network and the decoder in apparatus 2b, such as to implement the framework 1c of FIG. 1c.

FIG. 2c illustrates a block diagram of a telecommunications apparatus 2c including components of a framework for voice conversion according to yet another exemplary embodiment of the present invention. As shown, components of apparatus 2c with the same function as those of their counterparts in apparatuses 2a and 2b of FIGS. 2a and 2b, respectively, are denoted with the same reference numerals. As shown, apparatus 2c includes a memory 25 (connected to the CPU 22) configured for storing signals, such as encoding parameters referring to frequently required speech signals. As suggested above, these frequently required speech signals may include, for example, spoken menu items that can be read to visually impaired persons for facilitating use of apparatus 2c. In such instances, the CPU may be configured for fetching the corresponding encoding parameters from the memory and feeding the parameters to the decoder 12, which may be configured for decoding the parameters into a speech signal for emission by the speaker 24. As in the previous example (apparatus 2b), the decoder of apparatus 2c may include a converter for voice conversion, thereby permitting personalization of the voice that reads the menu items to the user. Alternatively, in instances in which the decoder does not include a converter, such personalization (if performed) may be performed during the generation of the encoding parameters by an encoder, or by a combination of an encoder and a converter. For example, the encoding parameters may be pre-installed in apparatus 2c, or may be received from a server (not shown) in the core network of a mobile communications system within which apparatus 2c operates.

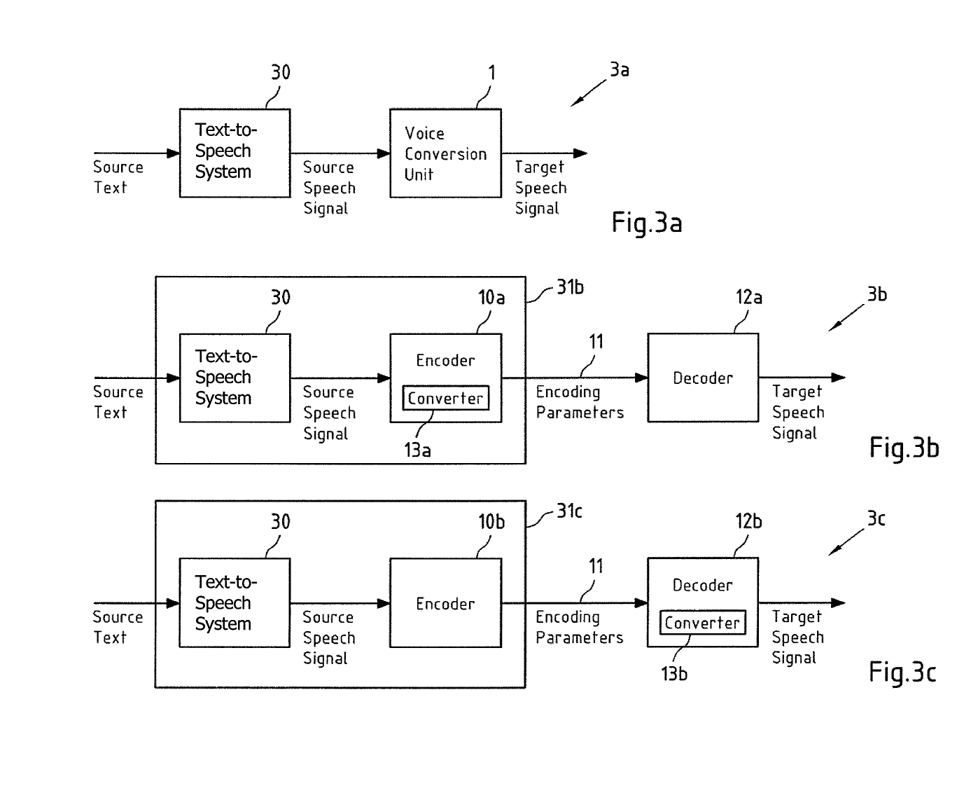

FIG. 3a is a schematic block diagram of a text-to-speech (TTS) converter 3a according to one exemplary embodiment of the present invention. The TTS converter of exemplary embodiments of the present invention may be particularly useful in a number of different contexts including, for example, reading of Short Message Service (SMS) messages to a user of a telecommunications apparatus, or reading of traffic information to a driver of a car via a car radio. As shown, the TTS converter includes a voice conversion unit 1, which may be implemented according any of the frameworks 1a, 1b and 1c of FIGS. 1a, 1b and 1c, respectively. The TTS converter includes a TTS system 30, which may be configured to receive source text and convert the source text into a source speech signal. The TTS system may, for example, have only one standard voice implemented. Thus, it may be useful for the voice conversion unit to perform voice conversion.

FIG. 3b is a schematic block diagram of a TTS converter 3b according to another exemplary embodiment of the present invention. As shown, components of TTS converter 3b with the same function as those of their counterparts in TTS converter 3a of FIG. 3a are denoted with the same reference numerals. The TTS converter 3b of FIG. 3b includes a unit 31b and a decoder 12a. The unit includes a TTS system 30 for converting a source text into a source speech signal, and an encoder 10a for encoding the source signal into encoding parameters. The encoder 10a may include a converter 13b for performing the actual voice conversion for the source speech signal. The encoding parameters output by the unit may then be transferred to the decoder, which is configured for decoding the encoding parameters to obtain the target speech signal. According to TTS converter 3b, the unit and the decoder may, for example, be embodied in different apparatuses (connected, e.g., by a wired or wireless link) where the unit is configured for performing TTS conversion, encoding and conversion. The block structure of the unit should therefore be understood functionally, so that, equally well, multiple, if not all, steps of TTS conversion, encoding and conversion may be performed in a common block.

FIG. 3c is a schematic block diagram of a TTS converter 3c according to yet another exemplary embodiment of the present invention. Again, components of TTS converter 3c with the same function as those of their counterparts in TTS converters 3a and 3b of FIGS. 3a and 3b, respectively, are denoted with the same reference numerals. In TTS converter 3c, the TTS system 30 and encoder 10b form a unit 31c, where the encoder 10b is not furnished with a voice converter as it was the case in unit 31b of TTS converter 3b (see FIG. 3b). Instead, in TTS converter 3c, the decoder 12b includes the voice converter 13b. The unit 31c is therefore configured to perform TTS conversion and encoding, while the decoder 12b is configured to perform the voice conversion and decoding. Similar to TTS converter 3b, in TTS converter 3c, the unit 31c and decoder 12b may be implemented in different apparatuses, which are connected to each other via a transmission link (e.g., wireless link) therebetween.

In accordance with exemplary embodiments of the present invention, voice conversion generally includes feature/parameter extraction (e.g., by encoder 10), conversion model training and voice conversion (e.g., by converter 13), and re-synthesis (e.g., by decoder 12). Each of these phases of voice conversion will now be described below in accordance with such exemplary embodiments of the present invention, although it should be understood that one or more of the respective phases may be performed in manners other than those described herein.

A. Feature/Parameter Extraction

A popular approach in parametric speech coding is to represent the speech signal or the vocal tract excitation signal by a sum of sine waves of arbitrary amplitudes, frequencies and phases:

$$s ( t ) = Re {\sum }_{m = 1}^{L ( t )} {a}_{m} ( t ) exp ( j [ {\int }_{0}^{t} {ω}_{m} ( t ) d t + {θ}_{m} ] ) , \qquad ( 1 )$$

where αₘ, ωₘ(t) and θₘ represent the amplitude, frequency and a fixed phase offset for the m-th sinusoidal component. To obtain a frame-wise representation, the parameters may be assumed to be constant over the analysis window. Thus, the discrete signal s(n) in a given frame may be approximated by

$$s ( t ) = {\sum }_{m = 1}^{L} {A}_{m} cos ( n {ω}_{m} + {θ}_{m} ) , \qquad ( 2 )$$

where Aₘ and θₘ represent the amplitude and the phase of each sine-wave component associated with the frequency track ωₘ, and L is the number of sine-wave components. In the underlying sinusoidal model, the parameters to be transmitted may include: the frequencies, the amplitudes, and the phases of the found sinusoidal components. The sinusoids are often assumed to be harmonically related at the multiple of the fundamental frequency ω₀(=2πf₀). During voice speech, No corresponds to speaker's pitch, but ω₀ has no physical meaning during unvoiced speech. To further simplify the model, it may be assumed that the sinusoids can be classified as continuous or random-phase sinusoids. The continuous sinusoids represent voiced speech, and can be modeled using a linearly evolving phase. The random-phase sinusoids, on the other hand, represent unvoiced noise-like speech that can be modeled using a random phase.

To facilitate both voice conversion and speech coding, the sinusoidal model described above can be applied to modeling the vocal tract excitation signal. The excitation signal can be obtained using the well-known linear prediction approach. In other words, the vocal tract contribution can be captured by the linear prediction analysis filter A(z) and the synthesis filter 1/A(z), while the excitation signal can be obtained by filtering the input signal x(t) using the linear prediction analysis filter A(z) as

$$s ( t ) = x ( t ) - {\sum }_{j = 1}^{N} {a}_{j} x ( t - j ) , \qquad ( 3 )$$

where N denotes the order of the linear prediction filter. In addition to the separation into the vocal tract model and the excitation model, the overall gain or energy can be used as a separate parameter to simplify the processing of the spectral information.

As described above, the speech representation may include three elements: i) vocal tract contribution modeled using linear prediction, ii) overall gain/energy, and iii) normalized excitation spectrum. The third of these elements, i.e., the residual spectrum, can be further represented using the pitch, the amplitudes of the sinusoids, and voicing information. The encoder 10 may therefore estimate or otherwise extract each of these parameters at regular (e.g., 10-ms) intervals from a source speech signal (e.g., 8-kHz speech signal), in accordance with any of a number of different techniques. Examples of a number of techniques for estimating or otherwise extracting different parameters are explained in greater detail below.

The coefficients of the linear prediction filter can be estimated in a number of different manners including, for example, in accordance with the autocorrelation method and the well-known Levinson-Durbin algorithm, alone or together with a mild bandwidth expansion. This approach helps ensure that the resulting filters are always stable. Each analysis frame includes a speech segment (e.g., 25-ms speech segment), windowed using a Hamming window. In this regard, the degree of the linear prediction filter can be set to 10 for 8-kHz speech, for sample. For further processing, the linear prediction coefficients may be converted into a line spectral frequency (LSF) representation. From the viewpoint of voice conversion, this representation can be very convenient since it has a close relation to formant locations and bandwidths, and may offer favorable properties for different types of processing and guarantees filter stability.

One exemplary algorithm for estimating the pitch may include computing a frequency-domain metric using a sinusoidal speech model matching approach. Then, a time-domain metric measuring the similarity between successive pitch cycles can be computed for a fixed number of pitch candidates that received the best frequency-domain scores. The actual pitch estimate can be obtained using the two metrics together with a pitch tracking algorithm that considers a fixed number of potential pitch candidates for each analysis frame. As a final step, the obtained pitch estimate can be further refined using a sinusoidal speech model matching based technique to achieve better than one-sample accuracy.

Once the final refined pitch value has been estimated, the parameters related to the residual spectrum can be extracted. For these parameters, the estimation can be performed in the frequency domain after applying variable-length windowing and fast Fourier transform (FFT). The voicing information can be first derived for the residual spectrum through analysis of voicing-specific spectral properties separately at each harmonic frequency. The spectral harmonic amplitude values can then be computed from the FFT spectrum. Each FFT bin can be associated with the harmonic frequency closest to it.

Similar to the other parameters, the gain/energy of the source speech signal can be estimated in a number of different manners. This estimation may, for example, be performed in the time domain using the root mean square energy. Alternatively, since the frame-wise energy may significantly vary depending on how many pitch peaks are located inside the frame, the estimation may instead compute the energy of a pitch-cycle length signal.

B. Voice Conversion Model Training and Conversion

Irrespective of exactly how the source and target speech signals are represented, conversion of a source speech signal to a target speech signal may be accomplished by the converter 13 in a number of different manners, including in accordance with a Gaussian Mixture Model (GMM) approach. Individual features/parameters may utilize different conversion functions or models, but generally, the GMM-based conversion approach has become popular, especially for vocal tract (LSF) conversion. As explained below, before conversion models may be utilized to convert respective parameters of source speech signals into corresponding parameters of target speech signals, the models are typically trained based on a sequence of feature vectors (for respective parameters) from the source and target speakers. The trained GMM-based models may then be used in the conversion phase of voice conversion in accordance with exemplary embodiments of the present invention. Thus, for example, a sequence of vocal tract (LSF) parameter/feature vectors from the source and target speakers may be utilized to train a GMM-based model from which vocal tract (LSF) parameters related to a source speech signal may be converted into corresponding vocal tract (LSF) parameters related to a target speech signal. Also, for example, a sequence of pitch parameter/feature vectors from the source and target speakers may be utilized to train a GMM-based model from which pitch parameters related to a source speech signal may be converted into corresponding pitch parameters related to a target speech signal.

1. Voice Conversion Model Training

The training of a GMM-based model may utilize aligned parametric data from the source and target voices. In this regard, alignment of the parametric data from the source and target voices may be performed in two steps. First, both the source and target speech signals may be segmented, and then a finer-level alignment may be performed within each segment. In accordance with one exemplary embodiment of the present invention, the segmentation may be performed at phoneme-level using hidden Markov models (HMMs), with the alignment utilizing dynamic time warping (DTW). Additionally or alternatively, manually labeled phoneme boundaries may be utilized if such information is available.

More particularly, the speech segmentation may be conducted using very simple techniques such as, for example, by measuring spectral change without taking into account knowledge about the underlying phoneme sequence. However, to achieve better performance, information about the phonetic content may be exploited, with segmentation performed using HMM-based models. Segmentation of the source and target speech signals in accordance with one exemplary embodiment may include estimating or otherwise extracting a sequence of feature vectors from the speech signals. The extraction may be performed frame-by-frame, using similar frames as in the parameter extraction procedure described above. Assuming the phoneme sequence associated with the corresponding speech is known, a compound HMM model may be built up by sequentially concatenating the phoneme HMM models. Next, the frame-based feature vectors may be associated with the states of the compound HMM model using Viterbi search to find the best path. By keeping track of the states, a backtracking procedure can be used to decode the maximum likelihood state sequence. The phoneme boundaries in time may then be recovered by following the transition change from one phoneme HMM to another.

As indicated above, the phoneme-level alignment obtained using the procedure above may be further refined by performing frame-level alignment using DTW. In this regard, DTW is a dynamic programming technique that can be used for finding the best alignment between two acoustic patterns. This may be considered functionally equivalent to finding the best path in a grid to map the acoustic features of one pattern to those of the other pattern. Finding the best path requires solving a minimization problem, minimizing the dissimilarity between the two speech patterns. In one exemplary embodiment, DTW may be applied on Bark-scaled LSF vectors, with the algorithm being constrained to operate within one phoneme segment at a time. In this exemplary embodiment, non-simultaneous silent segments may be disregarded.

Let x=[x₁, x₂, . . . xₙ] represent a sequence of feature vectors characterizing n frames of speech content produced by the source speaker, and let y=[y₁, y₂, . . . yₘ] represent a sequence of feature vectors characterizing m frames of the same speech content produced by the target speaker. The DTM algorithm may then result in a combination of aligned source and target vector sequences z=[z₁, z₂, . . . z_{w}], where zₖ=[xₚ^{T} y_{q}^{T}]^{T} and (xₚ, y_{q}) represents aligned vectors for frames p and q, respectively. The combination vector sequence z may then be used train a conversion model (e.g., GMM-based model).

Generally, a GMM allows the probability distribution of z to be written as the sum of L multivariate Gaussian components (classes), where its probability density function (pdf) may be written as follows:

$$\begin{matrix}p ( z ) = p ( x , y ) \\ = {\sum }_{l = 1}^{L} {α}_{l} \cdot N ( z ; {μ}_{l} , {\sum }_{l} ) , {\sum }_{l = 1}^{L} {α}_{l} \\ = 1 , {α}_{l} \geq 0 ,\end{matrix} \qquad ( 4 )$$

where αₗ represents the prior probability of z for the component l. Also in the preceding, N(z; μₗ, Σₗ) represents the Gaussian distribution with the mean vector μₗ and covariance matrix Σᵢ. GMM-based conversion models may therefore be trained by estimating the parameters (α, μ, Σ) to thereby model the distribution of x (the source speaker's spectral space), such as in accordance with any of a number of different techniques. In various exemplary embodiments of the present invention, the GMM-based conversion model may be trained iteratively through the well-known Expectation Maximization (EM) algorithm or K-means type of training algorithm.

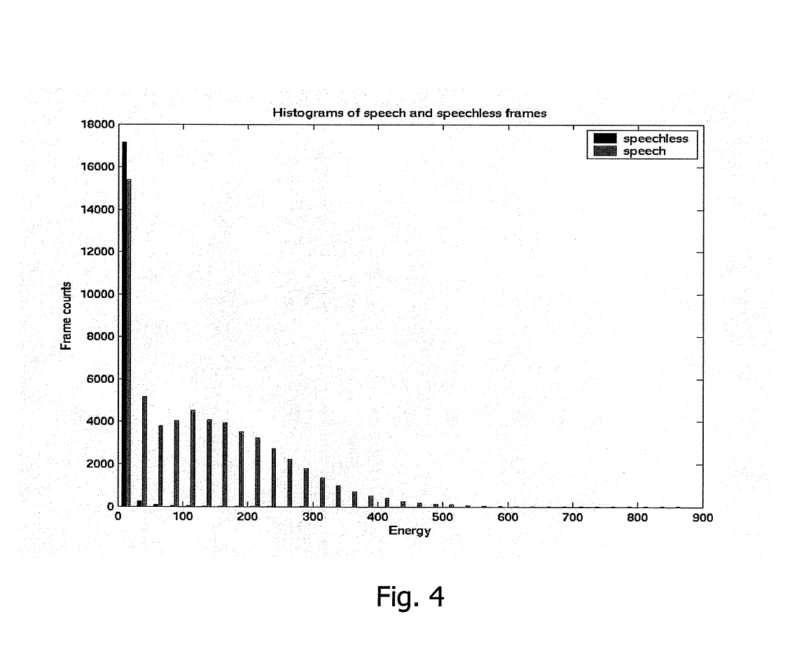

Conventionally, training a conversion model may be accomplished on aligned feature vectors x, y from the source and target speakers. If the training parametric data is noisy, however, the model accuracy may degrade. Before training the GMM-based conversion model, then, exemplary embodiments of the present invention may select for training only those parts of speech where speech content dominates the noise. For simplicity and without loss of generality, presume the case of training data affected by stationary noise (i.e., the noise distribution does not change in time). Consider estimation of the statistics of the frame-wise energy parameter over the sequence of training parametric data. As shown in FIG. 4, observation of the energy distributions of speech and non-speech frames reveals that speech frames with lower energies are more likely to be dominated by noise (smaller SNR), while speech frames with higher energies are cleaner (larger SNR). A method of training a conversion model in accordance with exemplary embodiments of the present invention may therefore further include estimating or otherwise extracting information related to the energies E (e.g., energy parameters) of the frames of the training source and target speech content. The feature vectors for frames more affected by noise may then be withheld from inclusion in the training procedure to thereby facilitate generation of a trained conversion model less affected by noise.

As indicated above, exemplary embodiments of the present invention may include estimating or otherwise extracting information related to the energies E (e.g., energy parameters) of frames of the training source and target speech signals, and as such, each frame of source and target speech content may be associated with information related to its energy. As also indicated above, each frame (at a time t) of speech content for the source speaker and target speaker may be characterized by or otherwise associated with a respective feature vector xₜ and yₜ, respectively. Accordingly, it may also be the case that each feature vector xₜ is also associated with information related to the energy Exₜ of a respective frame (at a time t) of speech content for the source speaker. Similarly, it may be the case that each feature vector yₜ is also associated with information related to the energy Eyₜ of a respective frame (at a time t) of speech content for the target speaker. As explained herein, the energy of a frame of speech content for the source speaker or target speaker, Exₜ or Eyₜ, may be generically referred to as energy E.

In accordance with exemplary embodiments of the present invention, a threshold energy value Etr may be calculated and compared to the energies of the frames of the source and target speech signals Exₜ and Eyₜ, respectively. In this regard, the threshold energy value Etr may be calculated in any of a number of different manners. For example, the threshold energy value Etr may be empirically determined as roughly the smallest energy of perceived and understandable speech, and may be some fraction of the highest level of noisy energy in non-speech frames. As a consequence, the energy E<Etr may indicate the frame is more likely to be non-speech than speech, and vice versa when E≧Etr. In this regard, the threshold energy value Etr may be considered a linear discriminator between the non-speech/noisy-speech pdf (lower SNR frames, a decreasing exponential in FIG. 4) and the pdf of higher SNR speech (a Gaussian in FIG. 4). In this regard, if so desired, delineating non-speech and speech frames may be complemented by voice activity detection, if so desired, such as to improve the classification at low energy levels.

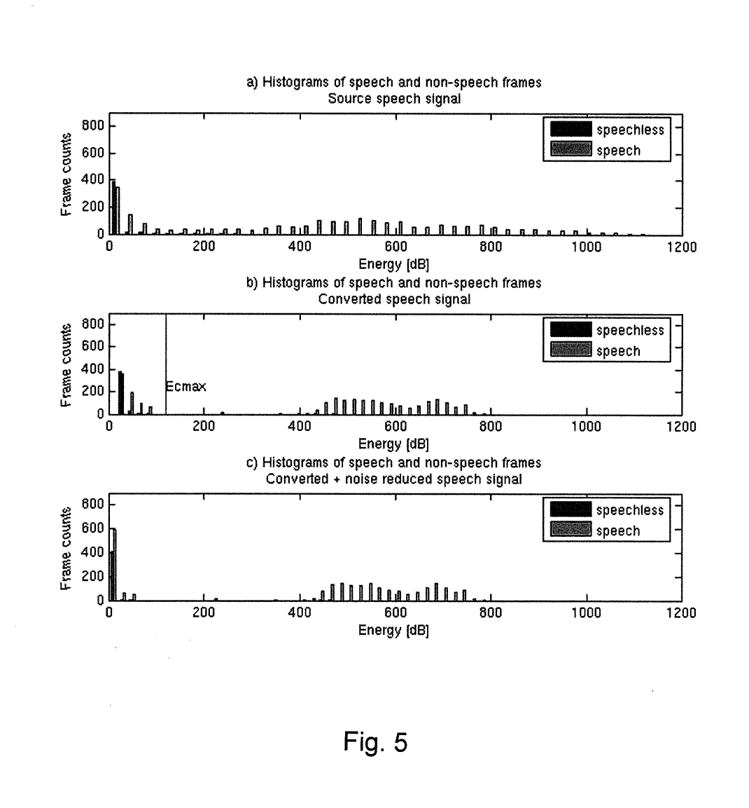

More particularly, for example, the threshold energy value Etr may be calculated by first considering an overlap in the distributions of speech versus non-speech energies for a converted training sequence x, where a threshold E_{Cmax} may be empirically found as shown in FIG. 5 as a tradeoff discriminator therebetween, e.g., source training material may be converted offline with histograms of speech versus non-speech energies then created as shown in FIG. 4 which then serve as a basis for the computation of E_{Cmax}. The threshold E_{Cmax} need not be a linear discriminator, but rather may be determined by listening tests. It may be both a small percentile of the speech pdf and a big percentile of the non-speech pdf, although the E_{Cmax} of one exemplary embodiment is selected so as to avoid harming the speech intelligibility when smaller energies are compressed.

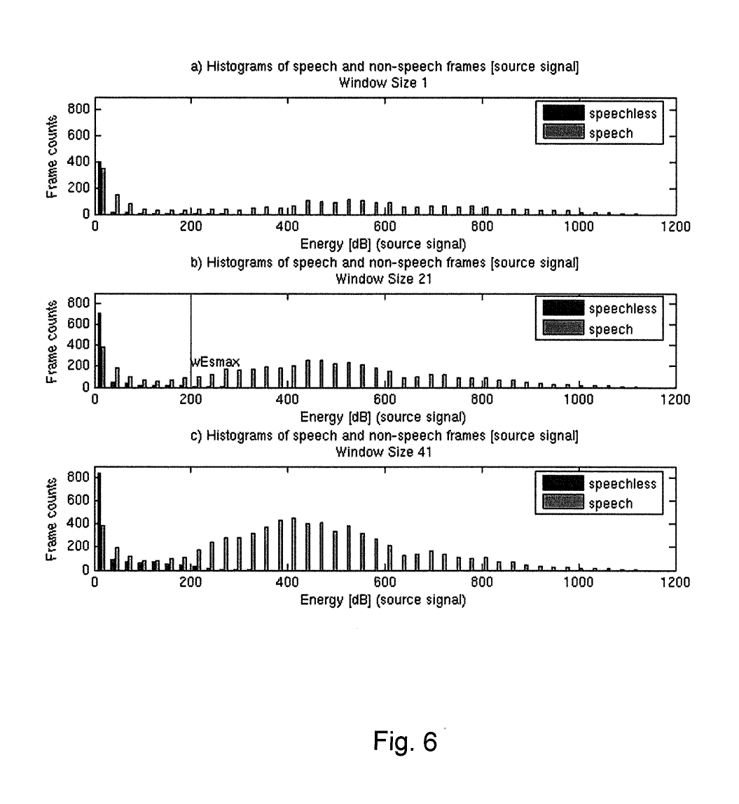

Along with selecting threshold E_{Cmax}, a value wE_{Smax} may be found or otherwise selected. The value wE_{Smax} may be selected in a number of different manners including based upon a primitive VAD developed as optimally sized windowed energy. The optimality of the window size may stay in that it may enable an optimal separation between pdfs of speech and non-speech windowed-energy. The value wE_{Smax} may be empirically found as shown in FIG. 6 as a tradeoff: it may not be the linear discriminator, but may ensure that is big enough to eliminate background noise and small enough to ensure speech integrity. For example, wE_{Smax} may be determined from source distributions of speech versus non-speech windowed energy. It should be noted, however, that the weighted energy may be performed on the source speech signal since it is typically clean in TTS systems.

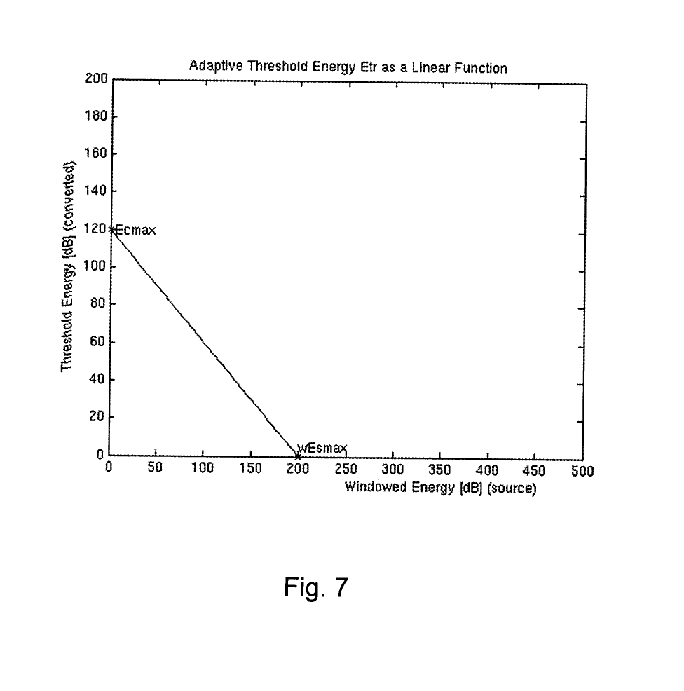

Now, as shown in FIG. 7, the threshold energy value Etr may be defined as a function of the found or otherwise selected E_{Cmax} and wE_{Smax}. More particularly, for example, the threshold energy value Etr may be defined as follows:

$$Etr = \frac{{E}_{C max}}{{wE}_{S max}} \cdot wE + {E}_{C max} \qquad ( 5 )$$

By comparing the threshold energy value Etr to the energies of the frames of the source and target speech signals xₜ, Eyₜ, respectively, exemplary embodiments of the present invention may identify one or more frames more likely associated with non-speech frames (e.g., E<Etr, identified by VAD as non-speech, etc.), and thereby identify one or more associated frame feature vectors (x, y) more likely to negatively impact the trained GMM-based conversion model. These identified feature vectors may then be withheld from inclusion in the training procedure to thereby facilitate generation of a trained conversion model less affected by noise. The respective feature vectors (x, y) may be withheld from inclusion in the training procedure at any of a number of different points in the during the model training. In one embodiment, for example, the respective feature vectors (x, y) may be withheld from inclusion in the training procedure during formation of the vector sequence z for training the GMM-based model. Thus, in accordance with exemplary embodiments of the present invention, a noise-reduced vector sequence z′ for training the GMM-based model may be formed to only include vectors zₖ=[xₚ^{T} y_{q}^{T}]^{T} with aligned source and target vector sequences (xₚ, y_{q}) having associated energies Exₚ and Ey_{q} greater than or equal to (i.e., ≧) than the threshold energy value Etr. This noise-reduced vector sequence z′ may be formed in a number of different manners, such as by selecting the respective vectors zₖ from the original vector sequence z. Alternatively, the vector sequence z′ may be formed by removing, from the original vector sequence z, vectors zₖ=[xₚ^{T} y_{q}^{T}]^{T} with aligned source and target vector sequences (xₚ, y_{q}) having associated energies Exₚ and Ey_{q} less than (i.e., <) the threshold energy value Etr. Although the above description included, in the noise-reduced vector sequence z′, aligned source and target vector sequences (xₚ, y_{q}) having associated energies equal to the threshold energy value, the noise-reduced vector sequence z′ may alternatively withhold these sequences along with the sequences having associated energies less than the threshold energy value, if so desired.

2. Voice Conversion

After training a GMM-based model for each of one or more parameters representing speech content, the trained GMM-based model may be utilized to convert the respective parameter related to a source speech signal (e.g., source encoding parameter) produced by the source speaker into a corresponding parameter related to a target speech signal as produced by the target speaker (e.g., target encoding parameter). As indicated above, for example, one trained GMM-based model may be utilized to convert vocal tract (LSF) parameters related to a source speech signal into corresponding vocal tract (LSF) parameters related to a target speech signal. As also indicated above, for example, another trained GMM-based model may be utilized to convert pitch parameters related to a source speech signal into corresponding pitch parameters related to a target speech signal.

For a particular speech parameter, the conversion of the speech parameter may follow a scheme where the respective, trained GMM-model parameterize a linear function that minimizes the mean squared error (MSE) between the converted source and target vectors. In this regard, the conversion function may be implemented as follows:

$$\begin{matrix}\begin{matrix}F ( x ) = E ( y \vert x ) \\ = {\sum }_{i = 1}^{L} {p}_{i} ( x ) \cdot ( {μ}_{i}^{y} + {\sum }_{i}^{yx} {( {\sum }_{i}^{xx} )}^{- 1} ( x - {μ}_{i}^{x} ) ) ,\end{matrix} \\ where & ( 6 ) \\ {p}_{i} ( x ) = \frac{{α}_{i} \cdot N ( x , {μ}_{i}^{x} , {\sum }_{i}^{xx} )}{{\sum }_{i = 1}^{L} {α}_{j} \cdot N ( x , {μ}_{i}^{x} , {\sum }_{j}^{xx} )} . & ( 7 )\end{matrix}$$

The covariance matrix Σᵢ may be formed as follows:

$$\begin{matrix}{\sum }_{i} = [ \begin{matrix}{\sum }_{i}^{xx} & {\sum }_{i}^{xy} \\ {\sum }_{i}^{yx} & {\sum }_{i}^{xx}\end{matrix} ] , \\ and & ( 8 ) \\ {μ}_{i} = [ \begin{matrix}{μ}_{i}^{x} \\ {μ}_{i}^{y}\end{matrix} ] , & ( 9 )\end{matrix}$$

represents the mean vector of the i-th Gaussian mixture of the GMM.

In one particular instance, conversion of LSF vectors may be performed using an extended vector that also includes the derivative of the LSF vector so as to take some dynamic context information into account, although the derivative may be removed after conversion (retaining the true LSF part). This combined feature vector may be transformed through GMM modeling using Equation (6). The conversion may also utilize several modes, each containing its own GMM model with one or more (e.g., 8) mixtures. In this regard, the modes may be achieved by clustering the LSF data in a data-driven manner.

In another particular instance, conversion of the pitch parameter (pitch vectors) may be performed through an associated GMM-based model in frequency domain using Equation (6) where, during unvoiced parts, “pitch” may be left unchanged. A multiple mixture (e.g., 8-mixture) GMM-based model used for pitch conversion may be trained on aligned data, with a requirement to have matched voicing between the source and the target data. After conversion of the pitch parameter, the residual amplitude spectrum may be processed accordingly as the length of the amplitude spectrum vector may depend on the pitch value at the corresponding time instant. Thus, the residual spectrum, although essentially unchanged, may be re-sampled to fit the dimension dictated by the converted pitch at that time.

C. Re-Synthesis

As described above, the speech representation may include three elements: i) vocal tract contribution modeled using linear prediction, ii) overall gain/energy, and iii) normalized excitation spectrum (represented using the pitch, the amplitudes of the sinusoids, and voicing information). After conversion, one or more desired features/parameters of the source speech signal that have been converted into corresponding features/parameters of the target speech signal, and any remaining features/parameters of the source speech signal not otherwise converted may collectively form features/parameters of the target speech signal. Thus, after conversion, the features/parameters of the target speech signal may be re-synthesized into a target speech signal. In this regard, the features/parameters of the target speech signal may be re-synthesized into the target speech signal in any of a number of different known manners, such as in a known pitch-synchronous manner.

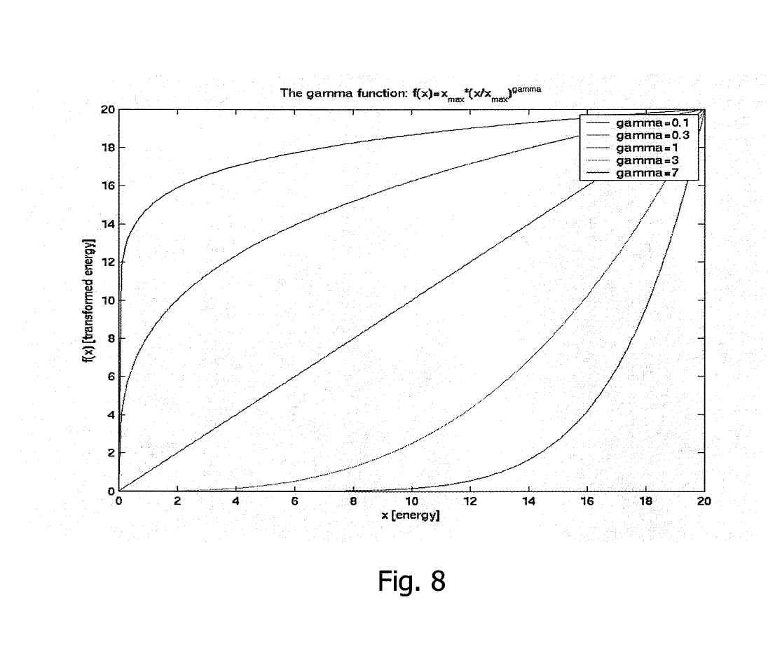

Conventional voice conversion techniques either treat the two classes of utterance content (speech and non-speech) as distinct with different models for conversion, which may generate disturbing artifacts at the speech and non-speech boundary (considering particularly, that VAD is typically not error-free); or treat all utterance content as one class and transform speech and non-speech frames using the same conversion functions. In the latter case, however, non-speech frames may amplify the input noise or simply become noisy as a consequence of the conversion. Thus, after converting the features/parameters of the source speech signal into the features/parameters of the target speech signal, and before re-synthesis of the target speech signal therefrom, the converter 13 or decoder 12 (or another apparatus therebetween) of exemplary embodiments of the present invention may apply a power function (see, e.g., FIG. 8) when Eiₜ<Etr. In the preceding inequality, Eiₜ represents information related to the energy (e.g., energy parameter) of a frame of the target speech content, and, as before, Etr represents a threshold energy value assuming for the moment that the model of the noise does not change over time. However, the threshold energy value can be made variable and adapted with the likelihood that a frame of content is speech (as opposed to non-speech), where the likelihood may be given in a number of different manners including, for example, soft VAD, smoothed windows energy or the like, as explained below. Application of the power function may at least partially suppress or reduce energies based on the likelihood that the respective frames belong to a non-speech segment. More particularly, application of the power function may at least partially suppress the target signal during non-speech segments, and may avoid amplifying background noise or bringing additional conversion noise. In addition, it may facilitate continuity and fluency of speech content, and may preserve the intelligibility of the speech because the frame features in the boundary may be attenuated depending on how likely the given frame is classified as speech. It may mean full suppression for true pause (non-speech) periods, no suppression for true speech periods, or light suppression for frames in the speech/non-speech transition periods. Irrespective of the exact manner of applying the power function, however, speech features (i.e., LSFs, pitches, voicings, etc.) may be converted into target speech with controllable energy.

The power function may be represented on a frame-wise basis (for each time t) in any of a number of different manners. For a target energy feature/parameter that has been converted from a corresponding source energy/parameter, for example, the power function Conv may be represented as follows:

$$Conv ( {Ei}_{t} ) = {( \frac{F ( {Ei}_{t} )}{F ( Etr )} )}^{γ} \cdot F ( Etr ) . \qquad ( 10 )$$

In the preceding, F represents the conventional energy transformation function (see Equation (6)), and γ represents a degree of suppression. The degree of suppression may be calculated or otherwise set to any of a number of different values, as reflected in FIG. 8, but in one exemplary embodiment, the degree of suppression may be set to γ=3.

Up to this point, it has been assumed that the model of the noise does not change over time (stationary). In reality, however, this may not be the case. Thus, in accordance with further aspect of exemplary embodiments of the present invention, the component applying the aforementioned power function (i.e., converter 13, decoder 12, other apparatus therebetween) may at least partially preserve the time-variant attributes of noise using an online mechanism to build and update local speech and non-speech models. The models of non-speech and speech segments can be iteratively updated in a local history window and, thus, the threshold energy value Etr that delineates them can be updated online in an adaptive manner. In addition or in the alternative, windows energy that includes the average energy across certain number of frames (windows) can be also used as adaptive factor. Further, an implementation could additionally or alternatively take advantage of a number of other techniques, such as soft VAD or the like, to detect speech and non-speech frames and help build the energy statistics. The threshold energy value Etr may, for example, be determined from local history models of speech versus non-speech energies by any one of the following approaches: (a) a determination of a weighted ratio, such as 20%, of speech versus non-speech energies, (b) based upon a mean and variance of the distributions of speech versus non-speech energies, (c) a determination of a weighted percentile of either a distribution of speech energies and/or a distribution of non-speech energies or (d) determination of the rank order value in speech versus non-speech energies, e.g., fifth smallest speech energy—provided that in any of these approaches Eₜᵣ is sufficiently low so as to not harm speech integrity and sufficiently high to ensure non-speech suppression, thereby serving as a tradeoff between these two competing concerns. Alternatively, such a weighted ratio may serve only for initialization until sufficient statistics are collected about “speech” and “noise” to compute a delineator. Even in this case, however, sudden changes in noise may require special treatment. It may therefore be better in these cases to update the threshold energy value Etr to, e.g., a weighted mean of local noise with increasing weights for recent frames until collected statistics become sufficient to compute the speech/noise delineator.

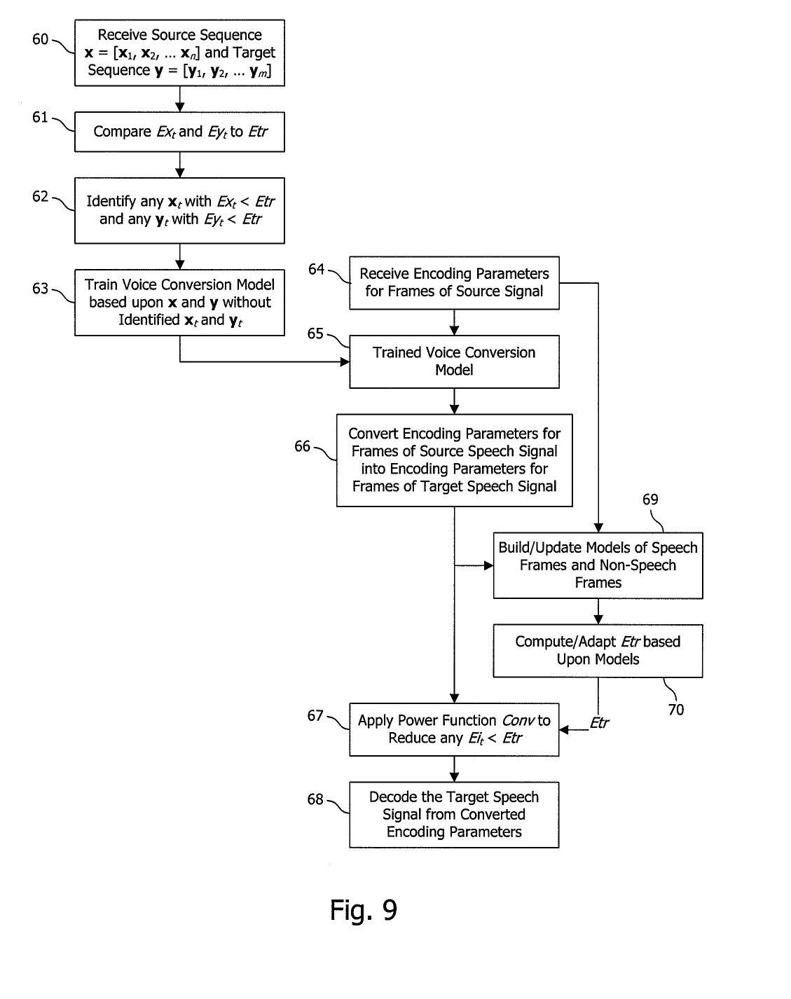

Referring now to FIG. 9, a flowchart is provided including various steps in a method of voice conversion in accordance with exemplary embodiments of the present invention. The method may include training a voice conversion model for converting at least some information characterizing a source speech signal (e.g., source encoding parameters) into corresponding information characterizing a target speech signal (e.g., target encoding parameters). In this regard, the source speech signal may be associated with a source voice, while the target speech signal may be a representation of the source speech signal associated with a target voice. More particularly, as shown in block 60, training the voice conversion model may include receiving information characterizing each frame in a sequence of frames of a source speech signal (e.g., x=[x₁, x₂, . . . xₙ]) and information characterizing each frame in a sequence of frames of a target speech signal (e.g., y=[y₁, y₂, . . . yₘ]), where each frame of the source and target speech signals having an associated energy (e.g., Exₜ, Eyₜ). As shown in block 61, the energies of the frames of the source and target speech signals (e.g., Exₜ, Eyₜ) may be compared to a threshold energy value (e.g., Etr). Then, based on the comparison, one or more frames of the source and target speech signals that have energies less than the threshold energy value (e.g., Exₜ<Etr; Eyₜ<Etr) may be identified, as shown in block 62. The voice conversion model may then be trained based upon the information characterizing at least some of the frames in the sequences of frames of the source and target speech signals, the conversion model being trained without the information characterizing at least some of the identified frames (e.g., x, y), as shown in block 63.

After training the voice conversion model, the model (shown at block 65) may be utilized in the conversion of source speech signals into target speech signals. In this regard, the method may further include receiving, into the trained voice conversion model, information characterizing each of a plurality of frames of a source speech signal (e.g., source encoding parameters), as shown in blocks 64 and 65. Then, as shown in block 66, at least some of the information characterizing each of the frames of the source speech signal may be converted into corresponding information characterizing each of a plurality of frames of a target speech signal (e.g., target encoding parameters) based upon the trained voice conversion model.

The information characterizing each frame of the target speech signal may include an energy (e.g., Eiₜ) of the respective frame (at time t). The method may therefore further include reducing the energy of one or more frames of the target speech signal that have an energy less than the threshold energy value (e.g., Eiₜ<Etr), as shown in block 67. The information characterizing the frames of the target speech signal (e.g., target encoding parameters) including the reduced energy may be configured for synthesizing the target speech signal. The target speech signal may then be synthesized or otherwise decoded from the information characterizing the frames of the target speech signal, including the converted information characterizing the respective frames, as shown in block 68.

Further, to account for a variable noise model, the method may include building models of speech frames and non-speech frames based upon the received information characterizing the source speech signal (e.g., source encoding parameters), as shown in block 69. The threshold energy value (e.g., Etr) may then be adapted based upon the models, the threshold energy value representing a delineation between the speech frames and the non-speech frames, as shown at block 70. The adapted threshold energy value may then be utilized as above, such as to determine the frames of the target speech signal for energy reduction (see block 67). It is noted that the foregoing discussion related to FIG. 9 references several different threshold energy values that may differ in value and in the manner of calculation.

According to one aspect of the present invention, the functions performed by one or more of the entities or components of the framework, such as the encoder 10, decoder 12 and/or converter 13, may be performed by various means, such as hardware and/or firmware (e.g., processor, application specific integrated circuit (ASIC), etc.), alone and/or under control of one or more computer program products, which may be stored in a non-volatile and/or volatile storage medium. The computer program product for performing one or more functions of exemplary embodiments of the present invention includes a computer-readable storage medium, such as the non-volatile storage medium, and software including computer-readable program code portions, such as a series of computer instructions, embodied in the computer-readable storage medium.

In this regard, FIG. 9 is a flowchart of methods, systems and program products according to the invention. It will be understood that each block or step of the flowchart, and combinations of blocks in the flowchart, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart's block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart's block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart's block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific exemplary embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising:
a converter for training a voice conversion model for converting at least some information characterizing a source speech signal into corresponding information characterizing a target speech signal, wherein the source speech signal is associated with a source voice, and the target speech signal is a representation of the source speech signal associated with a target voice, and wherein the converter is configured for training each voice conversion model by:
receiving information characterizing each frame in a sequence of frames of a source speech signal and information characterizing each frame in a sequence of frames of a target speech signal, each frame of the source and target speech signals having an associated energy;
comparing the energies of the frames of the source and target speech signals to a threshold energy value, and identifying one or more frames of the source and target speech signals that have energies less than the threshold energy value; and
training the voice conversion model based upon the information characterizing at least some of the frames in the sequences of frames of the source and target speech signals, the conversion model being trained without the information characterizing at least some of the identified frames.

2. An apparatus according to claim 1, wherein the converter is configured for training a voice conversion model for converting one or more encoding parameters characterizing a source speech signal into corresponding one or more encoding parameters characterizing a target speech signal, the encoding parameters including an energy parameter for each frame of a respective speech signal, and
wherein the converter is configured for comparing the energy parameters of the frames of the source and target speech signals to a threshold energy value, and identifying one or more frames of the source and target speech signals that have energy parameters less than the threshold energy value.

3. An apparatus according to claim 1, wherein the converter is further configured for receiving information characterizing each of a plurality of frames of a source speech signal from an encoder,
wherein the converter is configured for converting at least some of the information characterizing each of the frames of the source speech signal into corresponding information characterizing each of a plurality of frames of a target speech signal based upon the trained voice conversion model, information characterizing each frame of the target speech signal including the converted information, and including an energy of the respective frame.

4. An apparatus according to claim 3, wherein the converter is further configured for reducing the energy of one or more frames of the target speech signal that have an energy less than the threshold energy value, and
wherein the converter is configured for passing the information characterizing the frames of the target speech signal including the reduced energy to a decoder for synthesizing the target speech signal.

5. An apparatus according to claim 4, wherein the converter is further configured for building models of speech frames and non-speech frames based upon the received information characterizing the source speech signal, and
wherein the converter is configured for adapting the threshold energy value based upon the models, the threshold energy value representing a delineation between the speech frames and the non-speech frames.

6. An apparatus according to claim 3 further comprising:
a component located between the converter and the decoder for reducing the energy of one or more frames of the target speech signal that have an energy less than the threshold energy value, and
wherein the converter and the component are configured for passing the information characterizing the frames of the target speech signal including the reduced energy to a decoder for synthesizing the target speech signal.

7. An apparatus according to claim 6, wherein the component is further configured for building models of speech frames and non-speech frames based upon the received information characterizing the source speech signal, and
wherein the component is configured for adapting the threshold energy value based upon the models, the threshold energy value representing a delineation between the speech frames and the non-speech frames.

8. An apparatus according to claim 3 further comprising:
a decoder for receiving the information characterizing the frames of the target speech signal, and for reducing the energy of one or more frames of the target speech signal that have an energy less than the threshold energy value, and
wherein the decoder is configured for synthesizing the target speech signal based upon the information characterizing the frames of the target speech signal including the reduced energy.

9. An apparatus according to claim 8, wherein the decoder is further configured for building models of speech frames and non-speech frames based upon the received information characterizing the source speech signal, and
wherein the decoder is configured for adapting the threshold energy value based upon the models, the threshold energy value representing a delineation between the speech frames and the non-speech frames.

10. An apparatus comprising:
a converter for receiving information characterizing each of a plurality of frames of a source speech signal from an encoder, wherein the converter is configured for converting at least some information characterizing a source speech signal into corresponding information characterizing a target speech signal, wherein the source speech signal is associated with a source voice, and the target speech signal is a representation of the source speech signal associated with a target voice; and
a component for reducing the energy of one or more frames of the target speech signal that have an energy less than the threshold energy value,
wherein the converter and the component are configured for passing the information characterizing the frames of the target speech signal including the reduced energy to a decoder for synthesizing the target speech signal.

11. An apparatus according to claim 10, wherein the converter comprises the component.

12. An apparatus according to claim 10, wherein the component is located between the converter and the decoder.

13. An apparatus according to claim 10 further comprising:
a decoder for synthesizing the target speech signal based upon the information characterizing the frames of the target speech signal including the reduced energy, wherein the decoder comprises the component.

14. An apparatus according to claim 10, wherein the converter is configured for receiving encoding parameters characterizing a source speech signal,
wherein the converter is configured for converting one or more of the encoding parameters characterizing the source speech signal into corresponding one or more encoding parameters characterizing a target speech signal, encoding parameters characterizing each frame of the target speech signal including the converted encoding parameters, and including an energy of the respective frame,
wherein the converter is configured for reducing the energy parameter of one or more frames of the target speech signal, and
wherein the converter is configured for passing the encoding parameters characterizing the frames of the target speech signal including the reduced energy parameters.

15. An apparatus according to claim 10, wherein the component is further configured for building models of speech frames and non-speech frames based upon the received information characterizing the source speech signal, and
wherein the component is configured for adapting the threshold energy value based upon the models, the threshold energy value representing a delineation between the speech frames and the non-speech frames.

16. A method comprising:
training a voice conversion model for converting at least some information characterizing a source speech signal into corresponding information characterizing a target speech signal, wherein the source speech signal is associated with a source voice, and the target speech signal is a representation of the source speech signal associated with a target voice, and wherein training each voice conversion model comprises:
receiving information characterizing each frame in a sequence of frames of a source speech signal and information characterizing each frame in a sequence of frames of a target speech signal, each frame of the source and target speech signals having an associated energy;
comparing the energies of the frames of the source and target speech signals to a threshold energy value, and identifying one or more frames of the source and target speech signals that have energies less than the threshold energy value; and
training the voice conversion model based upon the information characterizing at least some of the frames in the sequences of frames of the source and target speech signals, the conversion model being trained without the information characterizing at least some of the identified frames.

17. A method according to claim 16, wherein training a voice conversion model comprises training a voice conversion model for converting one or more encoding parameters characterizing a source speech signal into corresponding one or more encoding parameters characterizing a target speech signal, the encoding parameters including an energy parameter for each frame of a respective speech signal, and
wherein comparing the energies and identifying one or more frames comprise comparing the energy parameters of the frames of the source and target speech signals to a threshold energy value, and identifying one or more frames of the source and target speech signals that have energy parameters less than the threshold energy value.

18. A method according to claim 16 further comprising:
receiving information characterizing each of a plurality of frames of a source speech signal from an encoder;
converting at least some of the information characterizing each of the frames of the source speech signal into corresponding information characterizing each of a plurality of frames of a target speech signal based upon the trained voice conversion model, information characterizing each frame of the target speech signal including the converted information, and including an energy of the respective frame;
reducing the energy of one or more frames of the target speech signal that have an energy less than the threshold energy value; and
passing the information characterizing the frames of the target speech signal including the reduced energy to a decoder for synthesizing the target speech signal.

19. A method according to claim 18 further comprising:
building models of speech frames and non-speech frames based upon the received information characterizing the source speech signal; and
adapting the threshold energy value based upon the models, the threshold energy value representing a delineation between the speech frames and the non-speech frames.

20. A method comprising:
receiving information characterizing each of a plurality of frames of a source speech signal from an encoder;
converting at least some information characterizing a source speech signal into corresponding information characterizing a target speech signal, wherein the source speech signal is associated with a source voice, and the target speech signal is a representation of the source speech signal associated with a target voice;
reducing the energy of one or more frames of the target speech signal that have an energy less than the threshold energy value; and
passing the information characterizing the frames of the target speech signal including the reduced energy to a decoder for synthesizing the target speech signal.

21. A method according to claim 20, wherein receiving information comprises receiving encoding parameters characterizing a source speech signal,
wherein converting at least some information comprises converting one or more of the encoding parameters characterizing the source speech signal into corresponding one or more encoding parameters characterizing a target speech signal, encoding parameters characterizing each frame of the target speech signal including the converted encoding parameters, and including an energy of the respective frame,
wherein reducing the energy comprises reducing the energy parameter of one or more frames of the target speech signal, and
wherein passing the information includes passing the encoding parameters characterizing the frames of the target speech signal including the reduced energy parameters.

22. A method according to claim 20 further comprising:
building models of speech frames and non-speech frames based upon the received information characterizing the source speech signal; and
adapting the threshold energy value based upon the models, the threshold energy value representing a delineation between the speech frames and the non-speech frames.

23. A computer program product comprising one or more computer-readable storage mediums having computer-readable program code portions stored therein, the computer-readable program portions comprising:
a first executable portion for training a voice conversion model for converting at least some information characterizing a source speech signal into corresponding information characterizing a target speech signal, wherein the source speech signal is associated with a source voice, and the target speech signal is a representation of the source speech signal associated with a target voice, and wherein the first executable portion is adapted to train each voice conversion model by:
receiving information characterizing each frame in a sequence of frames of a source speech signal and information characterizing each frame in a sequence of frames of a target speech signal, each frame of the source and target speech signals having an associated energy;
comparing the energies of the frames of the source and target speech signals to a threshold energy value, and identifying one or more frames of the source and target speech signals that have energies less than the threshold energy value; and
training the voice conversion model based upon the information characterizing at least some of the frames in the sequences of frames of the source and target speech signals, the conversion model being trained without the information characterizing at least some of the identified frames.

24. A computer program product according to claim 23, wherein the first executable portion is adapted to train a voice conversion model for converting one or more encoding parameters characterizing a source speech signal into corresponding one or more encoding parameters characterizing a target speech signal, the encoding parameters including an energy parameter for each frame of a respective speech signal, and
wherein the first executable portion is adapted to compare the energy parameters of the frames of the source and target speech signals to a threshold energy value, and adapted to identify one or more frames of the source and target speech signals that have energy parameters less than the threshold energy value.

25. A computer program product according to claim 23 further comprising:
a second executable portion for receiving information characterizing each of a plurality of frames of a source speech signal from an encoder;
a third executable portion for converting at least some of the information characterizing each of the frames of the source speech signal into corresponding information characterizing each of a plurality of frames of a target speech signal based upon the trained voice conversion model, information characterizing each frame of the target speech signal including the converted information, and including an energy of the respective frame;
a fourth executable portion for reducing the energy of one or more frames of the target speech signal that have an energy less than the threshold energy value; and
a fifth executable portion for passing the information characterizing the frames of the target speech signal including the reduced energy to a decoder for synthesizing the target speech signal.

26. A computer program product according to claim 25 further comprising:
a sixth executable portion for building models of speech frames and non-speech frames based upon the received information characterizing the source speech signal; and
a seventh executable portion for adapting the threshold energy value based upon the models, the threshold energy value representing a delineation between the speech frames and the non-speech frames.

27. A computer program product comprising one or more computer-readable storage mediums having computer-readable program code portions stored therein, the computer-readable program portions comprising:
a first executable portion for receiving information characterizing each of a plurality of frames of a source speech signal from an encoder;
a second executable portion for converting at least some information characterizing a source speech signal into corresponding information characterizing a target speech signal, wherein the source speech signal is associated with a source voice, and the target speech signal is a representation of the source speech signal associated with a target voice;
a third executable portion for reducing the energy of one or more frames of the target speech signal that have an energy less than the threshold energy value; and
a fourth executable portion for passing the information characterizing the frames of the target speech signal including the reduced energy to a decoder for synthesizing the target speech signal.

28. A computer program product according to claim 27, wherein the first executable portion is adapted to receive encoding parameters characterizing a source speech signal,
wherein the second executable portion is adapted to convert at least some information comprises converting one or more of the encoding parameters characterizing the source speech signal into corresponding one or more encoding parameters characterizing a target speech signal, encoding parameters characterizing each frame of the target speech signal including the converted encoding parameters, and including an energy of the respective frame,
wherein the third executable portion is adapted to reduce the energy comprises reducing the energy parameter of one or more frames of the target speech signal, and
wherein the fourth executable portion is adapted to pass the information includes passing the encoding parameters characterizing the frames of the target speech signal including the reduced energy parameters.

29. A computer program product according to claim 27 further comprising:
a fifth executable portion for building models of speech frames and non-speech frames based upon the received information characterizing the source speech signal; and
a sixth executable portion for adapting the threshold energy value based upon the models, the threshold energy value representing a delineation between the speech frames and the non-speech frames.
